(19) United States
(12) Patent Application Publication
(10) Pub. No.: US 2006/0218086 A1
(43) Pub. Date: Sep. 28, 2006

(54) Payee aliasing

(76) Inventors: Heather Campbell, Sunnyvale, CA (US); Warren J. Croce, Belmont, MA (US); John Reed Flora, Pleasanton, CA (US); Matthew James Homier, San Francisco, CA (US); Laxmi Kaushik, Fremont, CA (US); David Raymond Larsen, San Jose, CA (US); Costin Mugur Stefanescu, Newton, MA (US)

Correspondence Address: FENWICK & WEST LLP, SILICON VALLEY CENTER, 801 CALIFORNIA STREET, MOUNTAIN VIEW, CA, 94041, US

(21) Appl. No.: 11/148,959

(22) Filed: Jun. 8, 2005

Related U.S. Application Data
(60) Provisional application No. 60/665,430, filed on Mar. 24, 2005.

(51) Int. Cl. G06Q 40/00

(52) U.S. Cl. 705/39

(57) ABSTRACT

Field values such as payee names from downloaded transaction records are automatically renamed when appropriate, to make them consistent with corrected field values, such as actual payee names. If a downloaded field value corresponds to an alias for an corrected field value, the downloaded value is re-placed with the corrected field value. If a renaming rule applies to a downloaded field value, the downloaded field value is replaced according to the renaming rule. The invention automatically generates aliases and/or renaming rules when appropriate.

### Cross-Reference to Related Patent Applications

The present invention claims priority from U.S. Provisional Patent Application Serial No. 60/665,430 (Attorney Docket Number 9402), for CATEGORIZATION MANAGEMENT, filed Mar. 24, 2005, the disclosure of which is incorporated herein by reference.

### FIELD OF THE INVENTION

The present invention relates generally to handling of field values such as payee names in a personal financial software package or accounting package.

### BACKGROUND

Personal financial software packages and accounting software packages track various types of information for financial transactions. Typically, for each transaction, such information includes date, payee/payer name, amount, transaction type, category, and memo. Payee/payer information should be consistently entered from one transaction to another, so that accurate reports can be generated. For example, if payee information is entered differently from one transaction to another, the software may fail to recognize that the two transactions should be associated with the same actual payee entity; accordingly, any reports that are intended to aggregate data by payee may fail to properly aggregate the two transactions, instead treating them as though they are associated with different payees.

Another reason for consistent entry of payee data is that automatic categorization often relies on such consistent entry. If a user selects a category for a transaction, the software associates the payee name with the category. Thus, the next time a transaction for that payee is entered, the associated category can be automatically selected so that the user does not have to re-select it. If, however, payee data is not consistent from one transaction to the next, such automatic category selection will fail.

Many users download transaction data from a bank or other sources, such as credit card companies, investment service providers, utility providers, and other suppliers of various goods and services. Many users download some transactions and manually enter other transactions. Often, payee names are in a different format depending on whether they come from an online source or from manual entry by the user. For example, payee data from a bank often contains specific store location and identification information (for example, “Starbucks Pleasanton 998482”), when the user is only interested in the store name and will generally only enter the store name when entering a transaction manually (“Starbucks”). Typically, users would rather see all such transactions for “Starbucks” treated as though they are for a single payee, even if different Starbucks locations were visited. Data from online sources may also contain other information that the user might consider extraneous, such as transaction identifiers, dates, and the like. When such information appears within the payee field, the software fails to recognize the payee as being the same entity as was referenced in other transactions, since each time the payee name appears it is slightly different. In extreme cases, the payee name received from an online source may be completely different from the ordinary business name the user would normally use in referring to the payee.

### SUMMARY

Embodiments of the present invention can be implemented in either a personal financial software package or an accounting software package. It can be implemented as a feature of a software package, or as a feature of a web-based application or website, or as a plug-in that can be installed and used in connection with an existing software application.

Embodiments of the present invention provides a mechanism for allowing downloaded field values (such as payee names) having extraneous information (or having misspellings or other variations) to be recorded and recognized as being associated with the corrected field value (actual payee name) without the extraneous information or other variations. The present invention provides a technique for doing so with very little user intervention.

In one embodiment, a list of actual payee/payer names is maintained. When a transaction record is received (either by manual entry or via download from an online source), the software attempts to match the payee/payer data for the transaction against one of the actual names in the list. If no matching actual name is found, the user is prompted to select a name from the list; alternatively the user can indicate that the name that was received in the transaction record is a new payee/payer.

If the user selects a name from the list, a record is stored that associates the received payee/payer name with the corrected field value as it appears on the list. The received payee/payer name thus becomes an alias for the actual name. For reporting purposes, and for display purposes in the register and in other parts of the software package, the actual name is used. Thus, if the received payee/payer name is not identical to the received name for other transaction records that reference the same payee/payer, the software package can still recognize that the same payee/payer is being referenced, and that the two transaction records should be treated as though they are associated with the same entity. In addition, the mechanism of the present invention ensures that the user need not be presented with extraneous information, payee/payer names in different formats, unrecognizable and/or abbreviated names, and the like. Rather, the software application shields the user from such variations and simply presents the actual payee/payer name as it appears in the maintained list.

In addition, if another transaction record is received having the received payee/payer name as indicated in the alias record, the system of the present invention automatically substitutes the corrected field value (as specified in the alias record). Thus, the user need not manually rename the payee/payer.

In one embodiment, the association between received names and actual names is rule-based; thus, for example if the first N characters of a received name match the first N characters of the actual name, in one embodiment the software assumes that the same entity is being referenced. Wild cards, fuzzy matching, and other techniques can also be used. One skilled in the art will recognize that other association rules can be implemented.

In addition, in one embodiment certain particular “stop phrases” can be designated as not to be aliased. Thus, for example, transaction records having received payee/payer names such as INCOMING WIRE, PAYMENT THANK YOU, and the like, will not inadvertently be associated with other transaction records having similar received payee/payer names. Since several different payee/payers may use similar phrases of this kind, it is not necessarily the case that the same entity is involved when the same phrase appears in different transaction records.

In one embodiment, the list of actual payee/payer names is usereditable. In one embodiment, the associations between aliases and actual names are also user-editable.

In another embodiment, a set of renaming rules is maintained. When a transaction record is received (either by manual entry or via download from an online source), the software applies the renaming rules to the received payee/payer name in order to determine which payee/payer is being referred to.

For any transaction record received from an online source, if the user replaces the received payee/payer name with a substitute payee/payer name, a renaming rule is established. In one embodiment, the user is first asked whether a renaming rule should be established, and the rule is established only if the user assents. Then, in the future, the renaming rules are applied to received payee/ payer names so that the user need not manually rename the payee/payers.

Rules can be specified in terms of various types of conditions. If the condition is satisfied, the payee/payer for the transaction record is renamed accordingly. Examples of such conditions include:
Determining whether the received name is identical to a stored name (“equals”);
Determining whether the received names starts with a character string that is identical to the stored name (“starts with”);
Determining whether the received name contains the stored name (“contains”).

In one embodiment, the software selects which type of rule is appropriate given the particular received name and user-replaced name. In one embodiment, the software generates two (or more rules), for example an “equals” rule and a “starts with” rule.

In one embodiment, the user can request that any converted name be restored to its original state, for example by right-clicking on the name or otherwise activating a “restore original name” command. In one embodiment, the user can see the original name by hovering over the payee/payer name in a transaction.

### BRIEF DESCRIPTION OF THE DRAWINGS

The accompanying drawings illustrate several embodiments of the invention and, together with the description, serve to explain the principles of the invention.

FIG. 1A is a block diagram depicting a system architecture for an implementation of the present invention according to a first embodiment.

FIG. 1B is a block diagram depicting a system architecture for an implementation of the present invention according to a second embodiment.

FIG. 2 is a screen shot depicting an example of a Name Not Found dialog box.

FIGS. 3 and 4 are screen shots depicting an example of a Create Alias pop-up window according to one embodiment.

FIG. 5 is a screen shot depicting an example of an alias creation confirmation dialog box according to one embodiment.

FIG. 6 is a screen shot depicting an example of an Edit Customer screen including a Manage Aliases button, according to one embodiment.

FIG. 7 is a screen shot depicting an example of a Manage Aliases window according to one embodiment.

FIG. 8 is a screen shot depicting an example of a Delete Confirmation dialog box.

FIG. 9 is a flowchart depicting a method for creating payee aliases according to a first embodiment.

FIG. 10 is a flowchart depicting a method for creating renaming rules according to a second embodiment.

FIG. 11 is a screen shot depicting an example of a Renaming Rule Created dialog box according to one embodiment.

FIGS. 12, 13, and 14 are screen shots depicting an example of an Edit Renaming Rule dialog box according to one embodiment.

FIG. 15 is a block diagram depicting an architecture for implementing centralized storage of aliases according to one embodiment.

FIG. 16 is a block diagram depicting an architecture for implementing centralized storage of renaming rules according to one embodiment.

FIG. 17 depicts an interface for editing and accepting downloaded transaction records.

FIG. 18 depicts a pop-up display of a received field value, according to an embodiment of the present invention.

FIG. 19 depicts user interface mechanisms for accessing renaming rule configuration screens, according to one embodiment.

FIG. 20 depicts an online center dialog box including a button for accessing renaming rules, according to one embodiment.

FIG. 21 is a block diagram depicting an architecture for implementing centralized storage of categorization mappings according to one embodiment.

One skilled in the art will recognize that these Figures are merely examples of the operation of the invention according to one embodiment, and that other user interface arrangements and modes of operation can be used without departing from the essential characteristics of the invention. In particular, the screen shots and user interface elements shown in the Figures are merely exemplary; other layouts, arrangements, formats, and user interface features may be provided without departing from the essential characteristics of the present invention.

### DETAILED DESCRIPTION OF EMBODIMENTS

The present invention is now described more fully with reference to the accompanying Figures, in which several embodiments of the invention are shown. The present invention may be embodied in many different forms and should not be construed as limited to the embodiments set forth herein. Rather these embodiments are provided so that this disclosure will be complete and will fully convey principles of the invention to those skilled in the art.

For illustrative purposes, embodiments of the invention are described in connection with management of field values in a personal financial software package or accounting package. Various specific details are set forth herein and in the Figures, to aid in understanding the present invention. However, such specific details are intended to be illustrative, and are not intended to restrict in any way the scope of the present invention as claimed herein. In particular, one skilled in the art will recognize that the invention can be used in connection with payee names, payer names, or any other elements of financial transactions. References herein to “payee names” should thus be taken as merely exemplary, and are not intended to limit the invention to that particular transaction component. In addition, the particular screen layouts, appearance, and terminology as depicted and described herein, are intended to be illustrative and exemplary, and in no way limit the scope of the invention as claimed.

In one embodiment, the present invention is implemented in a conventional personal computer system running an operating system such as Microsoft Windows XP, available from Microsoft Corporation of Redmond, Wash., MacOS X, available from Apple Computer Inc. of Cupertino, Calif., Linux, Unix, operating systems developed by Microsoft, IBM, Sun Microsystems, Hewlett Packard, or any other operating system designed to generally manage operations on a computing device. In addition, the present invention can be implemented on devices other than desktop personal computers, such as for example personal digital assistants (PDAs), cell phones, computing devices in which one or more computing resources is located remotely and accessed via a network, and the like. The invention may be included as add-on software, or it may be a feature of an application that is bundled with the computer system or sold separately, or it may even be implemented as functionality embedded in hardware.

Output generated by the invention can be displayed on a screen, transmitted to a remote device, stored in a database or other storage mechanism, or used in any other way. In addition, in some embodiments, the invention makes use of input provided to the computer system via input devices such as a keyboard, mouse, touchpad, or the like. Such hardware components, including their operation and interactions with one another and with a central processing unit of the personal computer, are well known in the art of computer systems and therefore are not depicted here. In addition, for embodiments implemented in devices other than personal computers, other types of input and output components may be used, such as touch screens, thumbwheels, stylus-based input, and the like.

Overview

Field values received from online sources of downloadable financial information (such as financial institutions), for example those downloaded via Open Financial Exchange (OFX), or other formats acceptable for financial transaction download, often do not match the names that an online banking user would normally use to refer to a payee. Often the received field value contains extraneous information, or is formatted or abbreviated in a manner that causes it do differ from the ordinarily used name for the payee. These variations in received field values can make it difficult to generate accurate reports, because the software package may have difficulty identifying two or more transactions as having the same payee.

For example, a user might enter a payee name (field value) of “John Doe P. C.” Payment data is downloaded from an online source. For purposes of the following description, the term “online source” refers to any source of transaction information, whether the information is provided via the Internet, a local area network, a wide area network, or any other communications medium. The received payee name is shown as “John Doe Law Fir.” Because two different forms of the payee name exist, reports may fail to accurately aggregate transactions for that payee. In addition, the user may be confused because the received payee name differs from what he or she is used to. In addition, in some prior art software packages the user may be forced to add a new payee to their vendor list with a name corresponding to the received payee name; this causes extraneous payee names to appear in the vendor list.

Embodiments of the present invention allow the user to establish “John Doe Law Fir” as an alias for “John Doe P. C.” Then, received transaction records having “John Doe Law Fir” as the payee name are shown with a payee of “John Doe P. C.” when displayed to the user. The association between the two names is maintained internally, for example in a local data store.

For purposes of the above example, the problem and solution have been described in terms of payee names. However, the present invention can be used for establishing alias and/or renaming rules for any field of a financial transaction. Examples include payer names, categories, addresses, and the like.

The received field value from a downloaded transaction record can be added as an alias for any names list element in any data store or list; for example the alias may relate to a vendor, customer, employee, or the like. In one embodiment, each alias only points to one actual name; on the other hand, each actual name can be pointed to by any number of aliases.

Once an alias has been established, the software uses that alias name when matching and adding downloaded transaction records, in order to determine the actual name of the payee referenced in a downloaded transaction record. User intervention is not required, as the renaming or substitution of corrected field values can take place automatically.

System Architecture

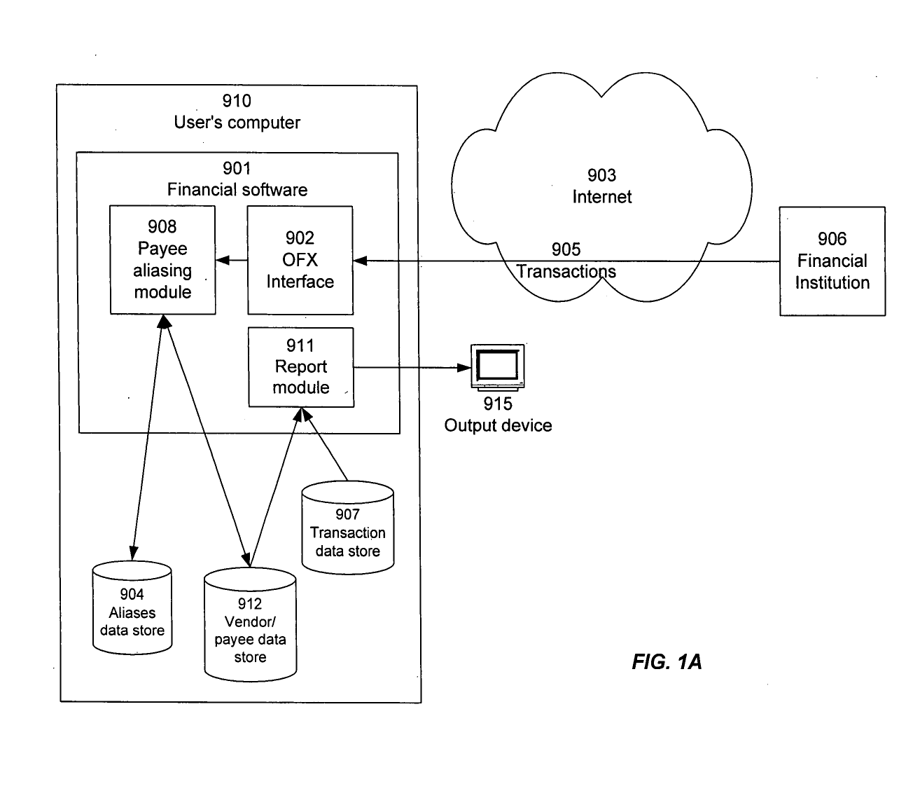

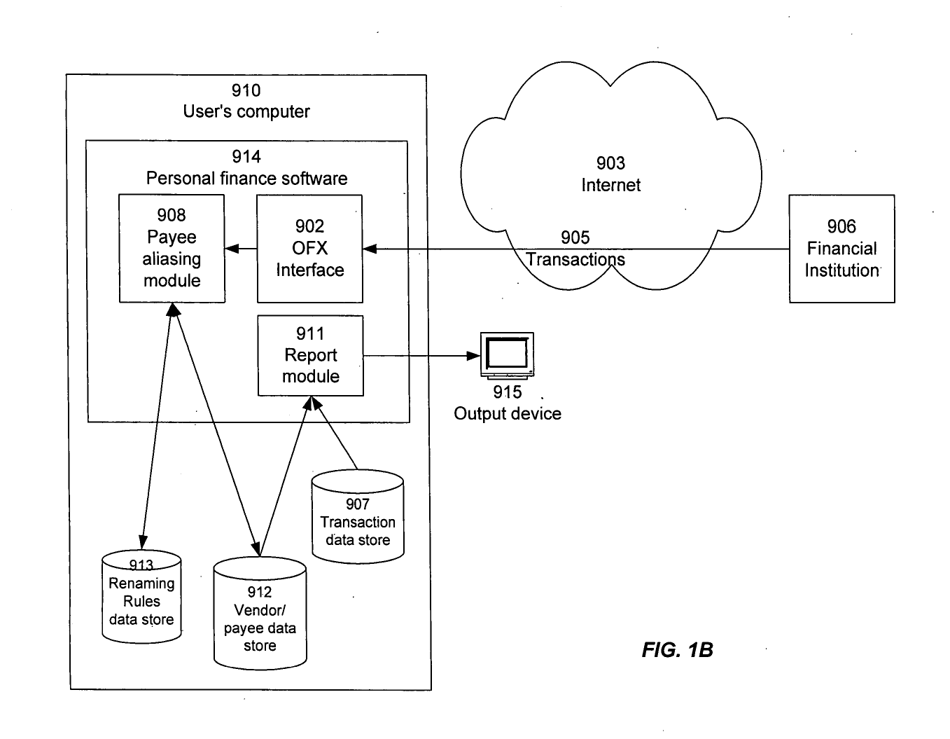

Referring now to FIG. 1A, there is shown an example of an architecture for implementing the functionality of the present invention according to one embodiment. User's computer 910 is a computer running an operating system and software applications, and having hardware components that are well known in the art and that need not be discussed here. User's computer 910 runs financial software 901 (which may be accounting software, personal financial/accounting software, or other software with functionality so as to allow the user to track his/her finances or the finances of another). Financial software 901 includes payee aliasing module 908 for performing the techniques described herein.

Aliases data store 904 contains records that associate aliases with corrected field values. Vendor/payee data store 912 contains records describing vendors/payees, including for example addresses, billing information, contact information, and the like. Transaction data store 907 contains records describing transactions. One skilled in the art will recognize that aliases data store 904, vendor/payee data store 912, and transaction data store 907 can be implemented as local databases, or remotely stored databases, data tables, flat files, or according to any other technique for storing such data. These data stores can be combined with one another, or split into smaller components, or combined with other data stores. One skilled in the art will recognize that many other types of data stores may also be provided, in order to implement the various features and functionality of financial software 901.

Financial software 901 receives transaction records 905 from financial institution 906 via a network. For illustrative purposes, FIG. 1A depicts the communications medium as the Internet 903, although one skilled in the art will recognize that other communications media such as local- or wide-area networks, or other types of networks, can be used. In one embodiment, financial software 901 includes OFX interface 902 for handling the incoming transaction records 905. OFX interface 902 communicates with payee aliasing module 908 to generate or obtain aliases for the payees referenced in received transaction records 905. Payee aliasing module 908 performs a payee lookup operation to determine if the received field value corresponds to an alias in aliases data store 904; if so, the corrected field value is stored in transaction data store 907. If an alias is to be added, financial software 901 writes a new record into aliases data store 904, associating the new alias with the corrected field value. In one embodiment, the user is prompted to assent to such an operation. In one embodiment, the user can also delete and/or edit previously generated alias data in aliases data store 904.

Report module 911 uses data from transaction data store 907 and vendor/payee data store 912 to generate reports, invoices, and the like. One skilled in the art will recognize that other functional components of financial software 901 may also use transaction data store 907 and vendor/payee data store 912; for example an on-screen register may use such information to generate a screen for entering and viewing transaction records. In any of these contexts, the present invention allows the corrected field value to be displayed and/or output, instead of a received field value that may not be recognizable or that may contain extraneous information.

Report module 911 sends reports and other output to output device 915 for display to the user.

Method and User Interface

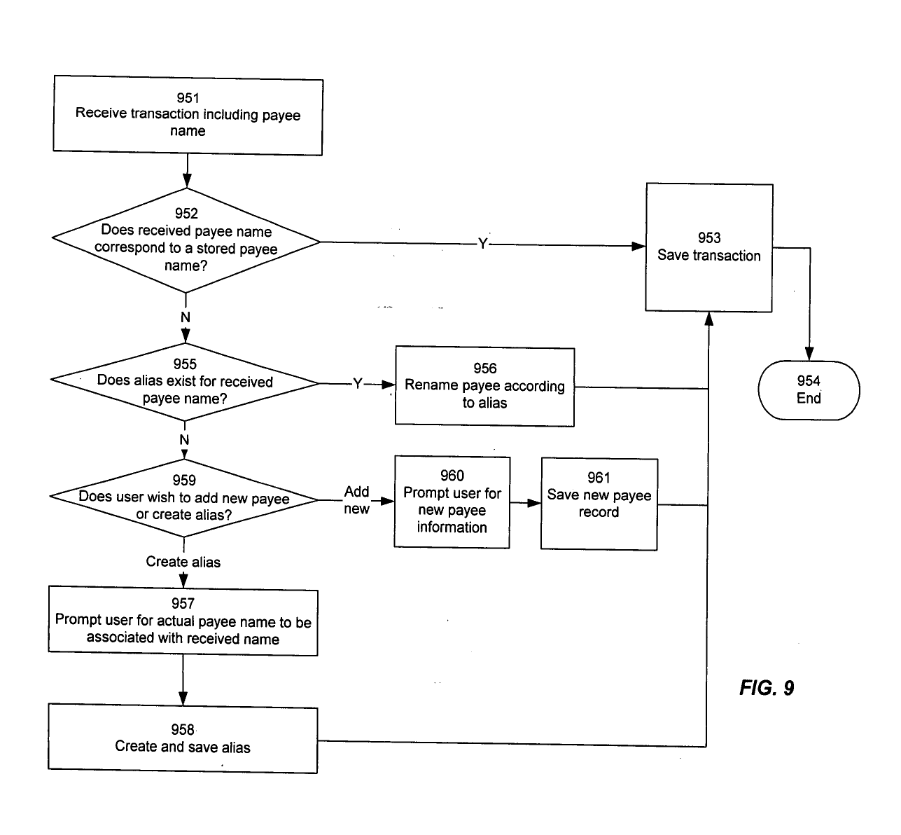

Referring now to FIG. 9, there is shown a flowchart depicting a method for creating payee aliases according to a first embodiment. In one embodiment, alias creation is built into the workflow for matching user-entered transaction records against transaction records received from an online source such as a bank. When the user attempts to add a transaction record with an unrecognized field value, the software presents the user with a dialog box for selecting among various operations including adding a new payee record or adding an alias pointing to an existing payee.

When a transaction record is received 951 (either by manual entry or via download from an online source), the software determines 952 whether the received field value corresponds to (matches) a stored field value from data store 912. If there is a match, the transaction record is saved 953 and the method ends 954.

If there is no match, the software determines 955 whether an alias exists for the received field value, by consulting aliases data store 904. If so, the software renames 956 the received field value, substituting the corrected field value as specified in the alias record in aliases data store 904. In one embodiment, this substitution is only made after prompting for, and receiving, the user's assent to the substitution. The transaction record is then saved 953 and the method ends 954.

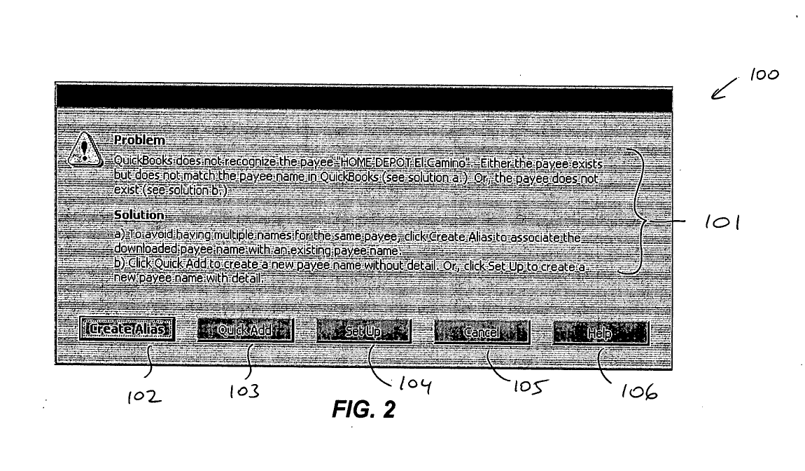

If no alias exists, the software prompts the user to either 959 add a new field value or create an alias to an existing one. Referring also to FIG. 2, there is shown an example of Name Not Found dialog box 100 for informing the user that an entered or received field value was not found, and for prompting the user to select between creating a new record and creating an alias to an existing record. Message 101 describes the situation, and Create Alias button 102, Quick Add button 103, Set Up button 104, Cancel button 105, and Help button 106 provide various options for proceeding. Create alias button 102 creates an alias using the entered or received field value. Quick Add button 103 creates a new record using the entered or received field value, using mostly default settings and values, according to techniques that are known in the art. Set Up button 104 creates a new record using the entered or received field value, allowing the user to specify more information than does the Quick Add feature, according to techniques that are known in the art. Cancel button 105 dismisses Name Not Found dialog box 100 and returns the user to his or her normal workflow with a blank field value. For example, if they were adding a downloaded transaction record to the register, the transaction record is now sitting in the register waiting to be recorded, and the field value is blank. The user can then enter a name manually and try again. Help button 106 provides access to an online help feature, according to techniques that are known in the art.

If the user wishes to add a new field value, the software prompts 960 the user for the new payee information according to techniques that are well known in the art. Upon receipt of this information, saves 961 a new record. The transaction record is then saved 953 and the method ends 954.

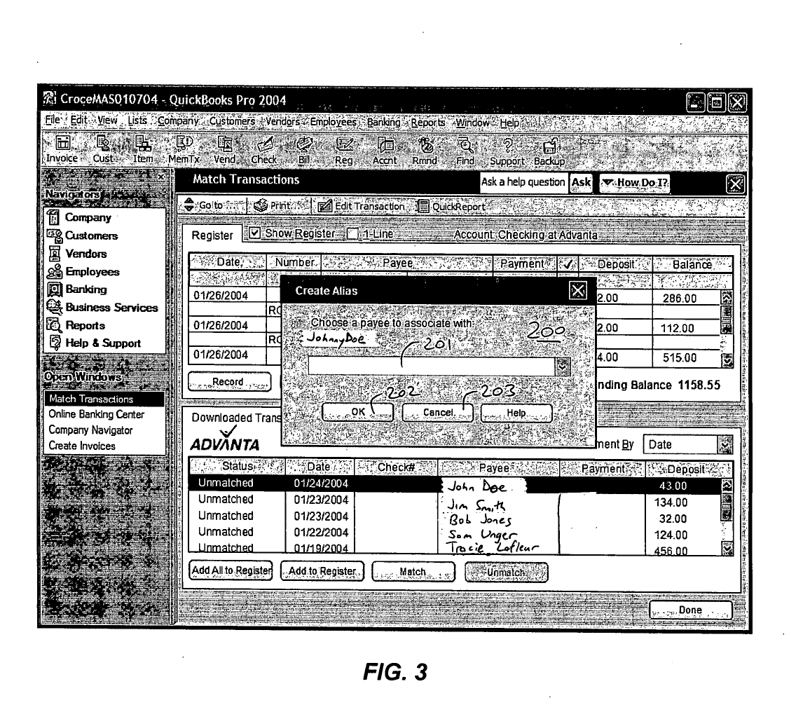

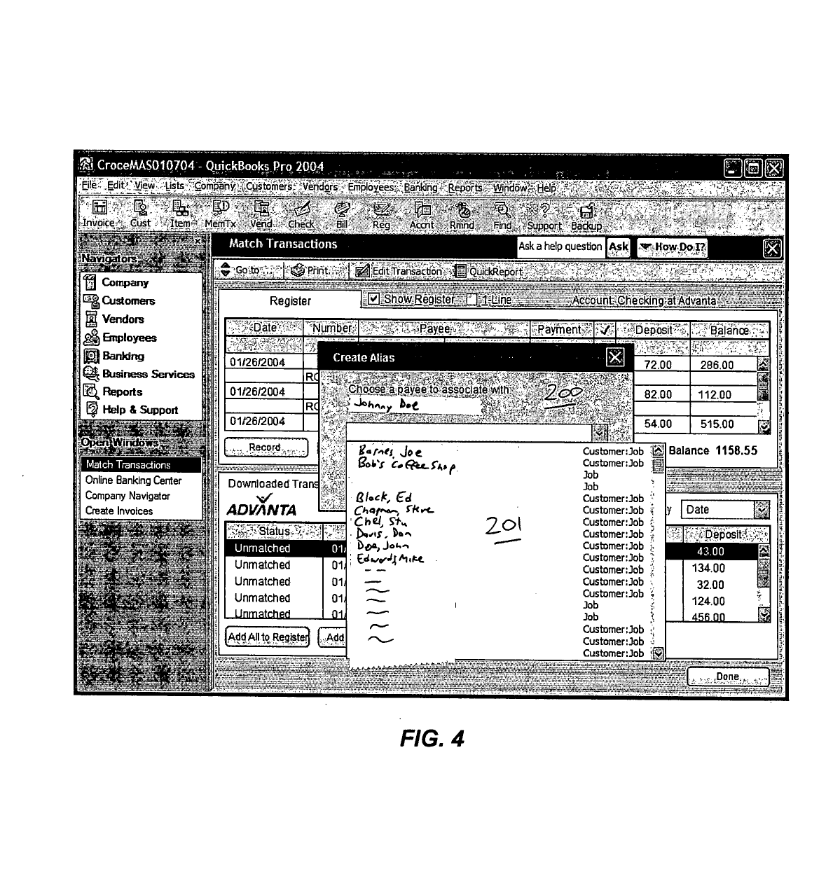

If the user wishes to create an alias, the software prompts 957 the user to select a corrected field value to be associated with the received field value. Upon clicking on Create Alias button 102, the user is presented with Create Alias pop-up window 200, as shown in FIGS. 3 and 4. The user can select a value from pulldown menu 201, which contains a list of previously entered field values. FIG. 3 depicts Create Alias pop-up window 200 before the user has clicked on pulldown menu 201, and FIG. 4 depicts Create Alias pop-up window 200 after the user has clicked on pulldown menu 201, thus activating pulldown menu 201 and causing field values to be displayed. In one embodiment, the field values presented in pulldown menu 201 are obtained from a database of field values, stored either locally or remotely. Cancel button 203 dismisses Create Alias pop-up window 200 and returns the user to his or her normal workflow with a blank field value. For example, if the user was adding a downloaded transaction record to the register, the transaction record is now sitting in the register waiting to be recorded, and the field value is blank.

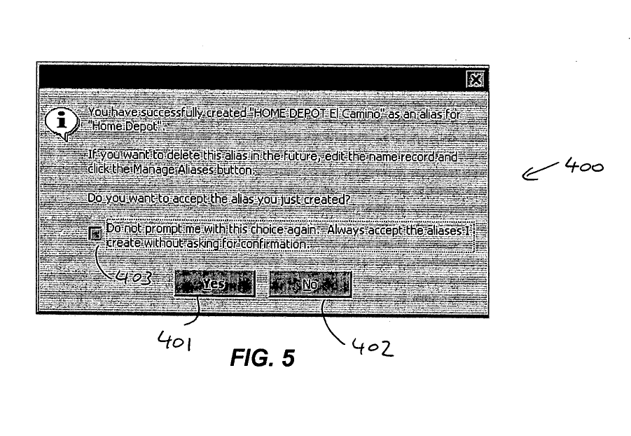

Once the user selects a name from pulldown menu 201, he or she clicks OK button 202 to create the alias. After he or she hits OK button 202, confirmation dialog box 400 is presented, as shown in FIG. 5. This confirmation dialog box 400 prompts the user to confirm the selected alias. The user can click on Yes 401 or No 402. The user can also check box 403 to bypass confirmation dialog box 400 in the future.

If the user hits Yes 401, the software creates and saves 958 the alias by adding a record to aliases data store 904, associating the received field value with the corrected field value. The transaction record is then saved 953 and the method ends 954. The user is then returned to his or her normal workflow. For example, if the user was adding a downloaded transaction record to the register, the user is returned to the register with the actual field value entered and ready to be recorded along with other details of the transaction record. In one embodiment, the register is populated with the corrected field value as opposed to the alias name. Once the alias has been added to aliases data store 904, the next time it appears in a received transaction record, the software automatically recognizes the alias and substitutes the corrected field value for the received field value in the register and in other places where appropriate. Create Alias pop-up window 200 need not be shown, since the alias has been automatically recognized. Thus, the user is shielded from viewing the received field value that may be in a different format or may have other problems or issues as described above.

If the user hits No 402, the alias is not added to aliases data store 904. Instead, the user is returned to his or her normal workflow as described above, with a blank field value.

In one embodiment, an alias that has been added to aliases data store 904 remains there even if the transaction record that caused it to be added is canceled or deleted.

In one embodiment, the user can turn on and off the aliasing functionality of the present invention, for example via a preferences dialog box (not shown) or other user interface control. When a user turns the payee functionality off, any aliases that have already been created remain in aliases data store 904, but the aliases have no effect. (Thus, if the user later turns on the functionality again, previously stored aliases are available for use).

In one embodiment, when the aliasing functionality is off, Name Not Found dialog box 100 does not include Create Alias button 102. In addition, the software does not use the alias names in aliases data store 904; it does not refer to alias names when deciding whether a field value is unrecognized, and it does not refer to aliases when performing automatic matching of downloaded transaction records with transaction records in the register.

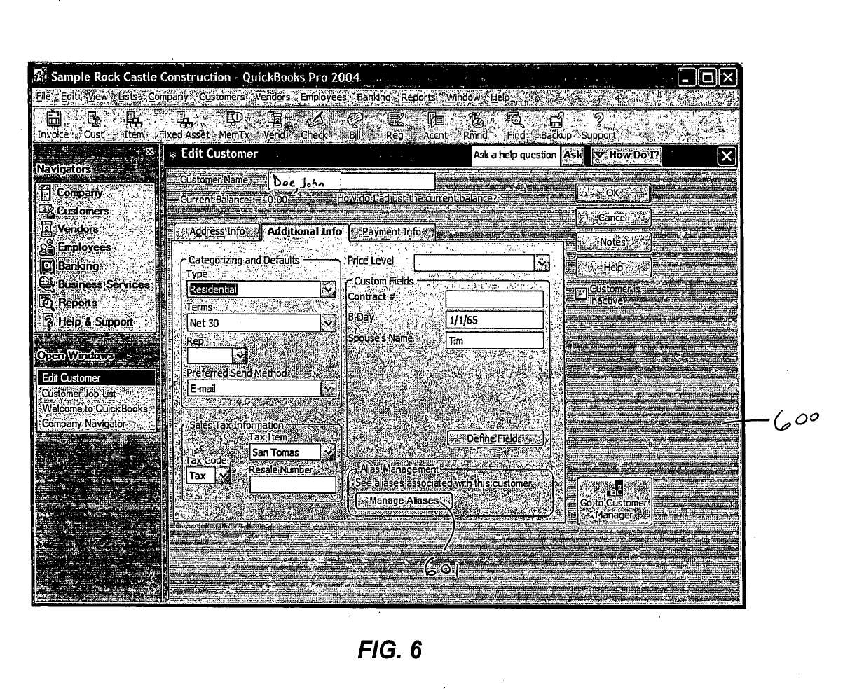

In one embodiment, the user can manage previously added aliases. In one embodiment, the user can activate an alias management screen for a particular payee (or other field value) via an onscreen button, keyboard command, pulldown menu, or the like. For example, buttons for accessing alias management functionality can be included in screens such as Edit Vendor, Edit Customer, Edit Employee, and Other Names menu. Referring now to FIG. 6, there is shown an example of a Manage Aliases button 601 on an Edit Customer screen 600. In one embodiment, Manage Aliases button 601 is only shown if a) the user has at least one account that is enabled for online banking, and b) the aliasing preference is on. In another embodiment, Manage Aliases button 601 does not appear, or is grayed out, if there are no aliases for the currently displayed customer. In another embodiment, if there are no aliases associated with the current field value, then an alert is displayed when the user hits Manage Aliases button 601.

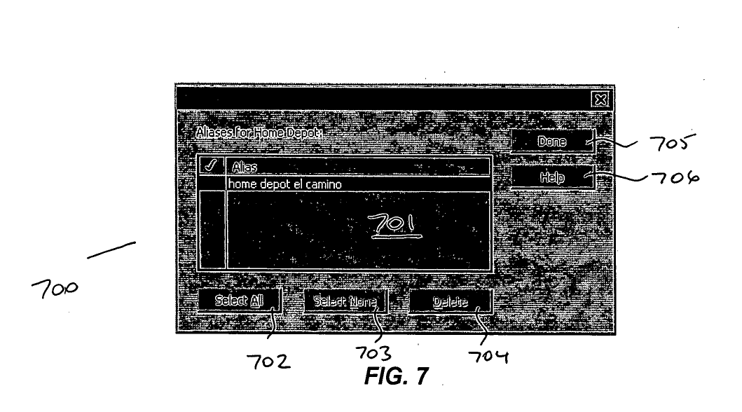

Referring now to FIG. 7, there is shown an example of Manage Aliases window 700 that is shown in response to the user clicking on Manage Aliases button 601. List 701 shows all aliases for the selected field value. List 701 is scrollable if appropriate. The user can select aliases from list 701 and can delete selected aliases by clicking on Delete button 704. Select All button 702 selects all aliases in list 701. Select None button 703 de-selects all aliases in list 701. Done button 705 dismisses Manage Aliases window 700, and Help button 706 provides access to on-screen help.

In another embodiment, additional functionality can be provided for editing aliases.

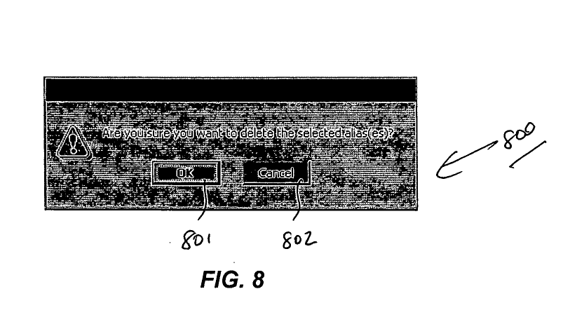

In one embodiment, if the user clicks on Delete button 704, a Delete Confirmation dialog box is presented before the aliases are deleted from aliases data store 904. Referring now to FIG. 8, there is shown an example of Delete Confirmation dialog box 800.

If the user hits OK 801, the selected aliases are deleted; if the user hits Cancel 802, aliases are not deleted. In either case, Delete Confirmation dialog box 800 is dismissed and the user is returned to the Manage Aliases window 700.

In one embodiment, the user can specify wild cards and/or patterns for aliases. For example, the user can specify an alias “Ernie*”, which would match any field value beginning with “Ernie”. In one embodiment, the user can create, edit, or delete aliases as desired.

In yet another embodiment, the software automatically generates wild-card and/or pattern-matching aliases based on detected usage patterns. For example, given the existence of an corrected field value of “Starbucks” and a received field value of “Starbucks 334229”, the software can automatically generate a wild-card alias of “Starbucks*”. Then, received field values containing other store numbers (such as “Starbucks 1213441” or “Starbucks 2949812”) are recognized as the same field value; the user does not have to specify or confirm the corrected field value associated with such received field values.

### Alternative Embodiment

In an alternative embodiment, the software includes a download rules manager having an interface allowing customers to manually instruct the software to always use a particular corrected field value (such as “Starbucks”) when a less attractive or duplicate downloaded field value is downloaded (such as “STARBUCKS 005 PLEASANTON 945”). In one embodiment, already recorded field values are not changed.

In addition to facilitating such manual instruction, the software package also automatically creates rules based on user edits to downloaded transaction records.

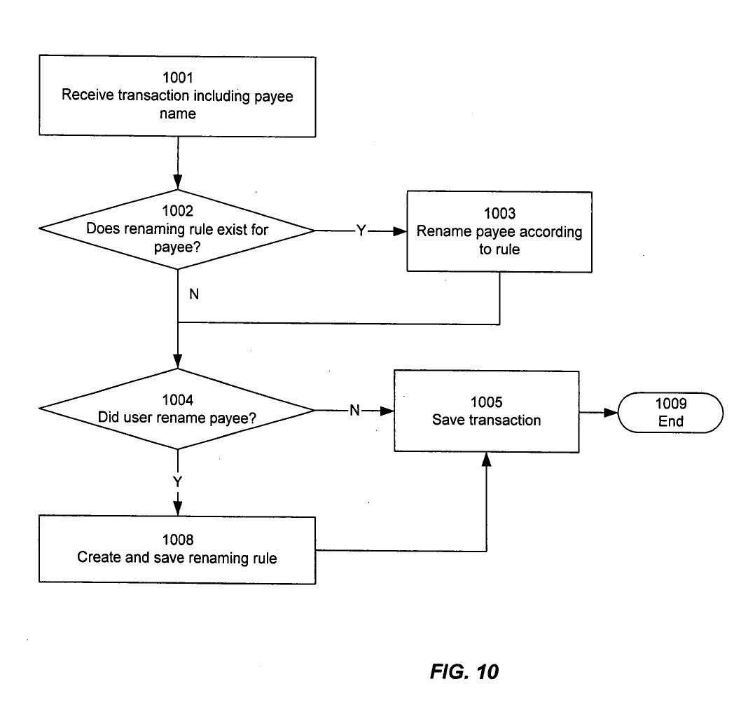

Referring now to FIG. 1B, there is shown a system architecture for such an embodiment of the present invention, as may be used in personal finance software. Referring also to FIG. 10, there is shown an example of a method for this alternative embodiment.

In this embodiment, a set of renaming rules is stored in renaming rules data store 915. When a transaction record is received 1001 (either by manual entry or via download from an online source), the software determines 1002 whether one or more renaming rules exist for the field value associated with the transaction record. If so, the software applies the renaming rules to the received field value in order to rename 1003 the payee accordingly.

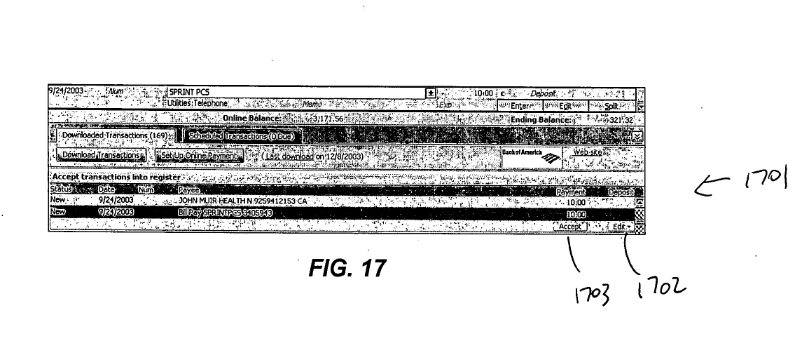

Referring now to FIG. 17, there is shown an interface 1701 for editing and accepting downloaded transaction records. The user can click on Edit button 1702 to edit a downloaded transaction record, or on Accept button 1703 to accept a downloaded transaction record.

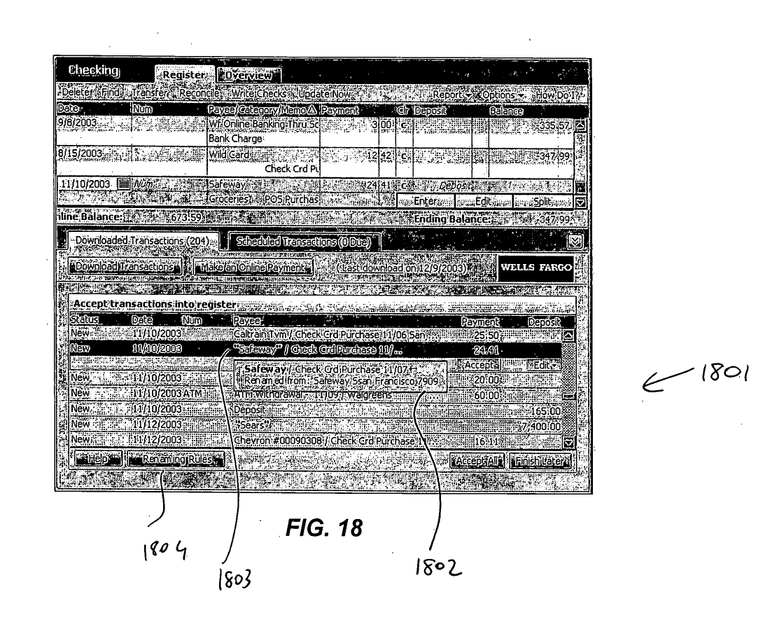

Referring now to FIG. 18, there is shown an interface 1801 for editing and accepting downloaded transaction records, wherein at least one field value has been renamed according to a previously established renaming. By hovering over the field value 1803 with an on-screen cursor (not shown), the user can cause pop-up display 1802 to be shown. Pop-up display 1802 shows the original received field value for the transaction record. Thus, even though the corrected field value 1803 is shown in the primary display, a user can at any time view the entered field value. In addition, in one embodiment, corrected field values are shown in quotation marks to provide an indication that they have been corrected (renamed). Renaming rules button 1804 provides access to renaming rules, so that the user can edit and/or delete them, as described elsewhere in this document.

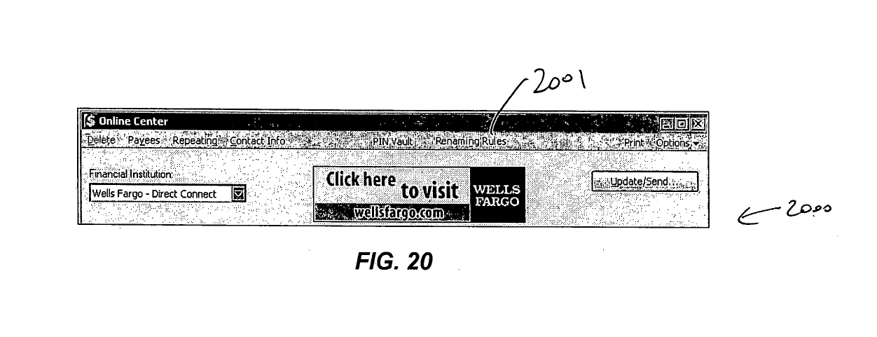

Referring now to FIG. 20, there is shown an online center dialog box 2000 including a Renaming Rules button 2001 for accessing Renaming Rules dialog box. One skilled in the art will recognize that access to renaming rules functionality can be provided anywhere within the software package.

For any transaction record received from an online source, the software determines 1004 whether the user replaced the received field value with a corrected field value. If so, the software creates and saves 1008 a renaming rule in data store 913. In one embodiment, the user is first asked whether a renaming rule should be established, and the rule is established only if the user assents. Then, in the future, the renaming rules are applied to received field values so that the user need not manually rename the payee.

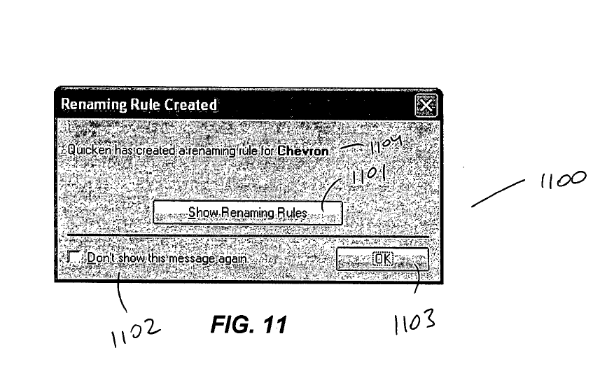

Referring also to FIG. 11, there is shown an example of Renaming Rule Created dialog box 1100 that is shown in one embodiment when a renaming rule is created. Message 1104 informs the user that a renaming rule has been created. Checkbox 1102 allows the user to indicate that he or she would rather not see such dialog boxes in the future. Show Renaming Rules button 1101 provides access to Edit Renaming Rule dialog box 1200 for editing, adding, and deleting renaming rules (described in more detail below). OK button 1103 dismisses Renaming Rule Created dialog box 1100.

The transaction record is then saved 1005 in a normal manner, and the method ends 1009.

Rules can be specified in terms of various types of conditions. If the condition is satisfied, the field value for the transaction record is renamed accordingly. Examples of such conditions include:
Determining whether the received field value is identical to a stored field value (“equals”);
Determining whether the received field value starts with a character string that is identical to the stored field value (“starts with”);
Determining whether the received field value contains the stored field value (“contains”).

In one embodiment, the software selects which type of rule is appropriate given the particular received field value and user-replaced field value. In one embodiment, the software generates two (or more rules), for example an “equals” rule and a “starts with” rule.

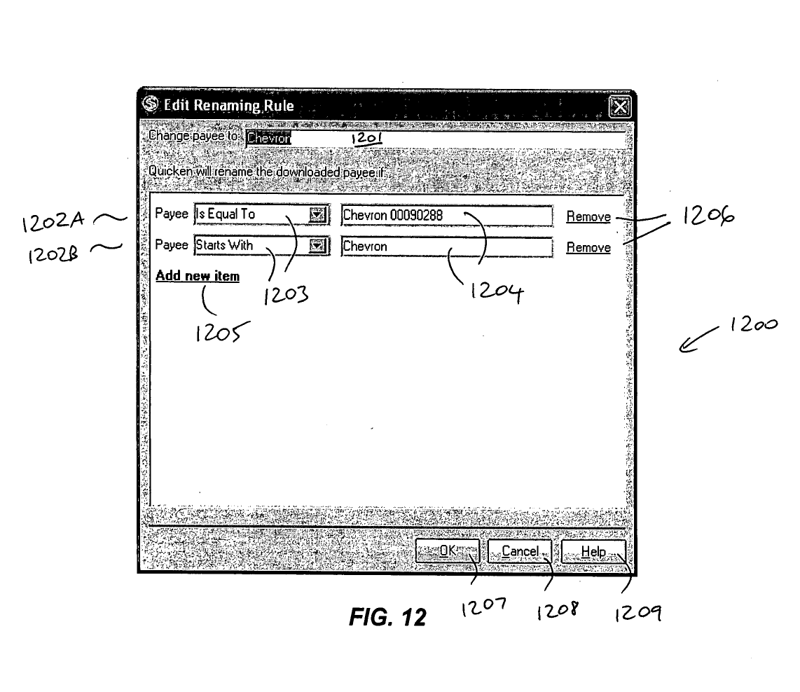

Referring now to FIGS. 12-14, there are shown screen shots depicting an example of an Edit Renaming Rule dialog box 1200 according to one embodiment. In one embodiment, Edit Renaming Rule dialog box 1200 is shown when the user clicks on Show Renaming Rules button 1101 in Renaming Rule Created dialog box 1100. In another embodiment, Edit Renaming Rule dialog box 1200 is shown when the user renames a field value that was associated with a downloaded transaction record.

In the example of FIG. 12, two rules 1202A, 1202B have been automatically generated for “Chevron”, based on the user having renamed “Chevron 00090288” to “Chevron”. Rule 1202A specifies that a payee name of “Chevron 00090288” will be renamed to “Chevron”, and rule 1202B specifies that a payee name starting with “Chevron” will be renamed to “Chevron”. Thus, rule 1202A covers the specific payee name “Chevron 00090288”, while rule 1202B covers other Chevron locations that have downloaded names starting with “Chevron” (presumably followed by a number or other identifier).

Pulldown menus 1203 allow the user to change the type of rule: “Is equals to”, “starts with”, or “contains”. Target fields 1204 allow the user to specify the text string that received field values will be compared to. Corrected field value field 1201 allows the user to specify the corrected field value; field values that satisfy the conditions specified in the renaming rules will be renamed to the name specified in corrected field value field 1201.

Remove buttons 1206 cause the corresponding rule to be removed (in one embodiment, a confirmation screen is shown first). Add new item button 1205 adds a new rule that can then be specified by the user.

The user can accept the displayed rules by clicking OK button 1207 or can cancel the creation/editing of the displayed rules by clicking on Cancel button 1208. Help button 1209 provides access to on-screen help functionality.

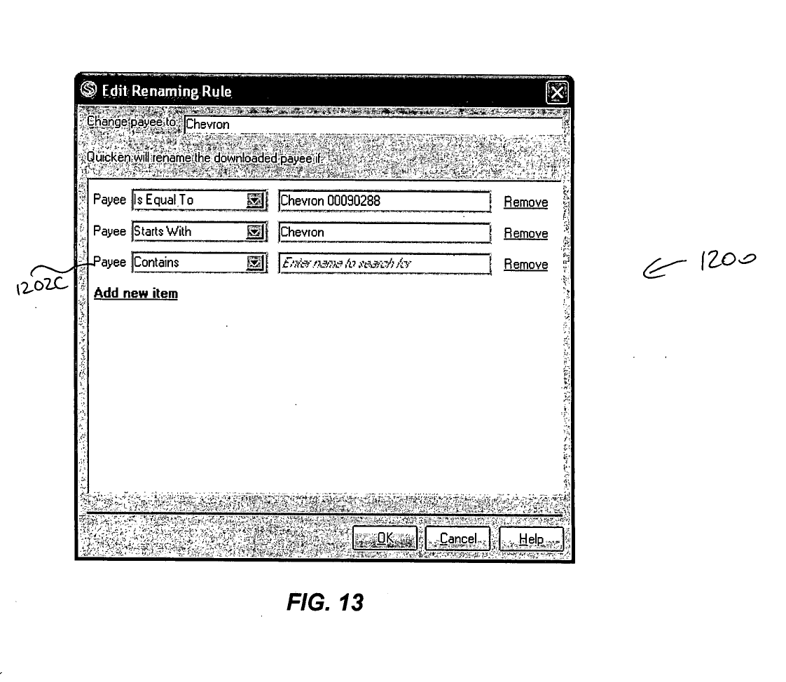

FIG. 13 depicts Edit Renaming Rule dialog box 1200 after the user has clicked on Add new item button 1205. A new rule 1202C has been added. It is blank because the user has not yet specified its parameters.

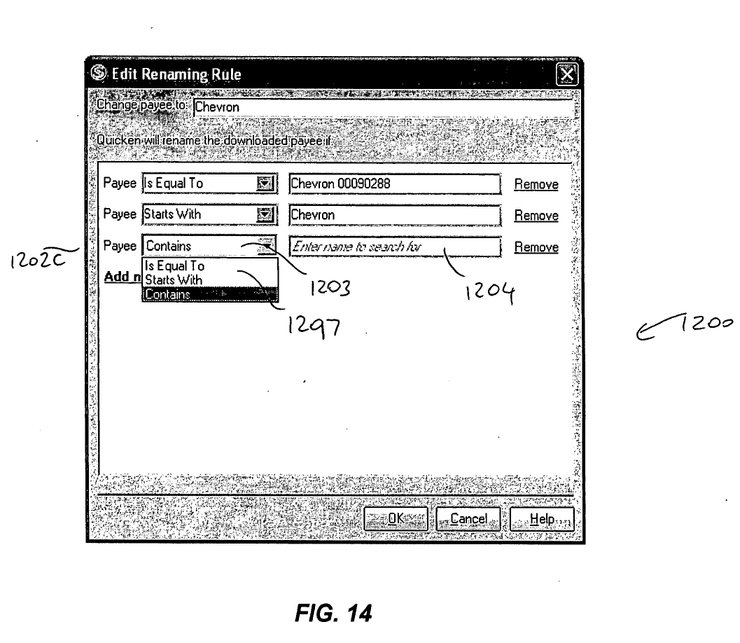

FIG. 14 depicts Edit Renaming Rule dialog box 1200 after the user has clicked on pulldown menu 1203 for rule 1202C, causing menu options 1297 to be displayed. As discussed above, three menu options 1297 are shown: “Is equals to”, “starts with”, and “contains”. The user can select among options 1297 to specify the type of rule being created. The user can enter text in target field 1204 to specify the text to be matched by the rule.

In one embodiment, for any transaction record in a register, the user can request that any converted field value be restored to its original state, for example by right-clicking on the field value or otherwise activating a “restore original name” command. In one embodiment, the user can see the original field value by hovering over the field value in a transaction record. Thus, in one embodiment, when a field value is renamed the original received field value is retained as well. This ensures that the original field value will be available if needed, in order to revert back to the original field value or to display it for the user.

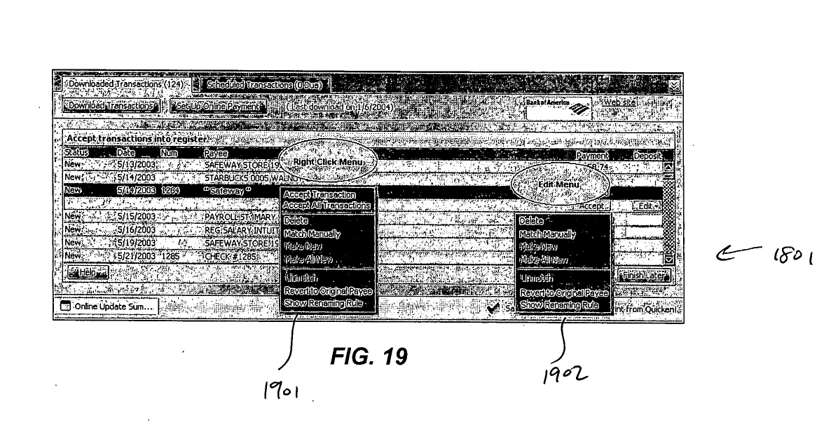

Examples of user interface mechanisms for restoring or reverting to original field values are shown in FIG. 19. The user interface mechanisms shown in FIG. 19 may be available, for example, from within interface 1801. Right-click menu 1901 is activated for a transaction by right-clicking while the cursor is positioned over the transaction. Commands in right-click menu 1901 include, for example, “Match Manually”, “Revert to Original Payee”, and “Show Renaming Rule”. Similar commands are also available from the Edit menu 1902 (shown for illustrative purposes overlaid on interface 1801).

In one embodiment, the Revert option is only available when the transaction record has previously been renamed; otherwise the command is inactive (grayed out).

In one embodiment, renaming rules only affect field values for transaction records downloaded in the future, and do not affect previously recorded transaction records.

In one embodiment, a renaming rule is created when the user edits a field value for a not-yet-accepted downloaded transaction record that is not al-ready mapped to a corrected field value.

In one embodiment, when a field value for a downloaded transaction record is edited to an existing renamed field value, an additional ‘is equal to’ rule is created for that downloaded field value.

In one embodiment, no automatic renaming rule created when a previously accepted downloaded transaction record is edited. In another embodiment, the renaming rule is created if the downloaded transaction record was accepted via an “Accept All” command.

Applying Renaming Rules

The following is an example of application of renaming rules according to one embodiment.

In one embodiment, when more than one renaming rule might apply, the rule having the greatest number of matching characters takes precedence. For example:

Starts with vs. Starts with

| | Separate | | | Renamed |
|---|---|---|---|---|
| # | Rules | Value | Initial Downloaded Payee | Payee |
| 1 | Starts with | AAA | AAA SANRAMON | AAA |
| 2 | Starts with | AAA | AAA TOWING | AAA Towing |
| | | Tow | COMPANY34356 | |

Explanation: The downloaded payee ‘AAA TOWING COMPANY34356’ will map to the payee ‘AAA Towing’ because it has a better value confidence.

Contains vs. Contains

| | Separate | | | Renamed |
|---|---|---|---|---|
| # | Rules | Value | Initial Downloaded Payee | Payee |
| 1 | Contains | 76 | POS GAS:FUEL 76 | 76 Gas Station |
| 2 | Contains | Star- | STARBUCKS MTVIEW | Starbucks Cof- |
| | | bucks | 769076 | fee |

Explanation: The downloaded payee ’STARBUCKS MTVIEW 769076’ will map to the payee ‘Starbucks Coffee’ even though it contains ‘76’ because it has a better value confidence with ‘Starbucks’.

Starts with vs. Contains

| | Separate | | | Renamed |
|---|---|---|---|---|
| # | Rules | Value | Initial Downloaded Payee | Payee |
| 1 | Starts | Safe- | SAFEWAY STORE 098767890 | Safeway Store |
| | With | way | | |
| 2 | Contains | Safe | SAFE HOME SECURITY | Safe Home Se- |
| | | | | curity |

Explanation: The new downloaded payee ‘SAFEWAY STORE 8888888’ will map to the payee ‘Safeway Store’ even though it contains ‘Safe’ be cause it has a better value confidence with ‘Safeway’.

In one embodiment, if character value is equal, the logical order to success then falls to the specific type of rule, in this specific order:
‘is equal to’ is the primary rule.
‘starts with’ is the secondary rule.
‘contains’ is the third rule.

In one embodiment, if character value match and rule are equal, then alphanumeric rules are given precedence.

Centralized Storage of Aliases and/or Renaming Rules

In one embodiment, field value aliases and/or renaming rules are transmitted to a server for storage. The aliases and/or rules may be stored at the server instead of or in addition to local storage at the client machine. Storing the aliases and/or rules at a server allows other client machines to access the aliases and/or rules. Thus, one user can take advantage of aliases and/or rules that have been generated in response to another user's input.

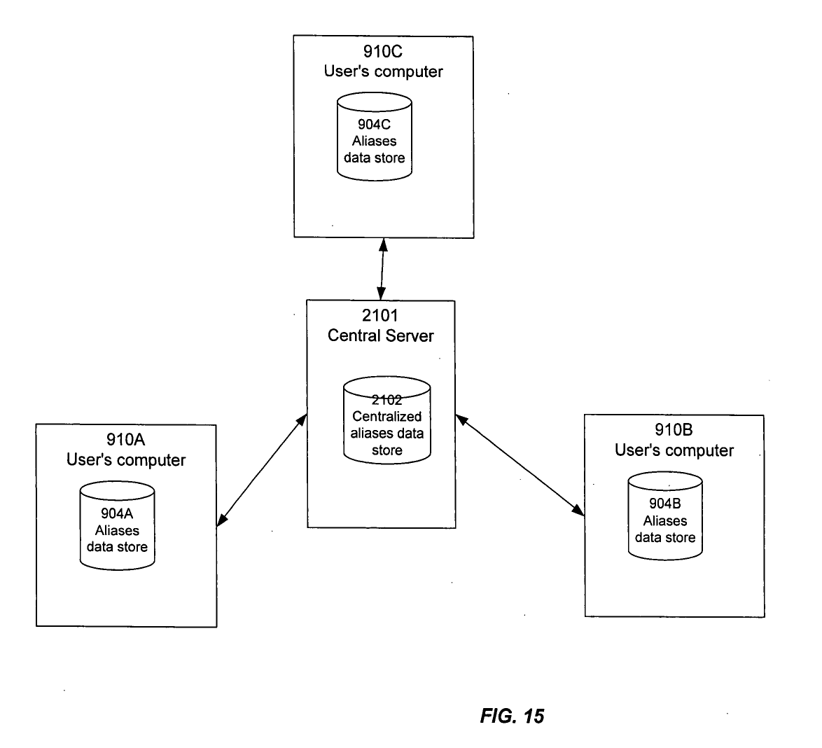

Referring now to FIG. 15, there is shown a block diagram depicting an architecture for implementing centralized storage of aliases according to one embodiment. Centralized aliases data store 2102 is located in or associated with central server 2101. Client machines such as users' computers 910A, 910B, and 910C communicate with central server 2101, for example over the Internet. Users' computers 910A, 910B, and 910C periodically transmit aliases to central server 2101, as described in more detail below. Users' computers 910A, 910B, and 910C periodically receive aliases from central server 2101, either in response to a need to check whether a payee should be renamed, or in order to update their local alias data stores 904A, 904B, 904C, as described in more detail below.

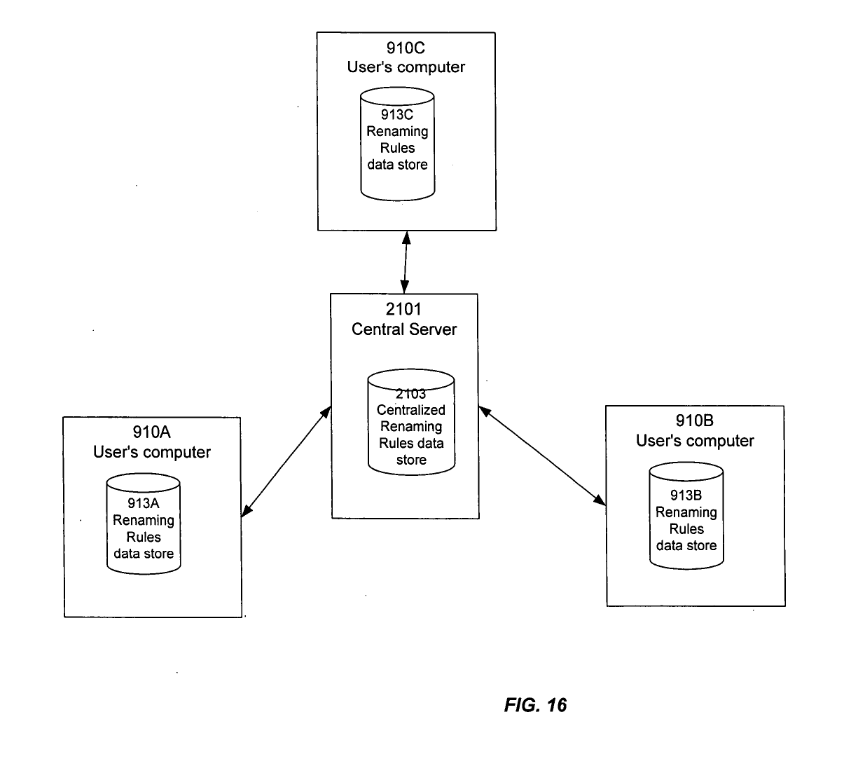

Referring now to FIG. 16, there is shown a block diagram depicting an architecture for implementing centralized storage of renaming rules according to one embodiment. Centralized renaming rule data store 2103 is located in or associated with central server 2101. Client machines such as users' computers 910A, 910B, and 910C communicate with central server 2101, for example over the Internet. Users' computers 910A, 910B, and 910C periodically transmit renaming rules to central server 2101, as described in more detail below. Users' computers 910A, 910B, and 910C periodically receive renaming rules from central server 2101, either in response to a need to check whether a payee should be renamed, or in order to update their renaming rules data stores 913A, 913B, 913C, as described in more detail below.

In one embodiment, such aliases and/or rules are made available for general use only when they have been corroborated by some predetermined number of client machines. For example, a particular renaming rule might be transmitted to a server when it is generated by a client machine; however, it is not immediately made available for use by other client machines. Then, when at least two other client machines have independently generated the same renaming rule (or a sufficiently similar renaming rule), the rule is flagged as having been corroborated, and it is now made available for use by other client machines. In this manner, the chance of inadvertent use/publication of spurious, inaccurate renaming rules and/or aliases is minimized.

In one embodiment, when a client machine receives a downloaded transaction record, it checks its own local data store of aliases and/or renaming rules, and also checks the server-based data store. Aliases and/or renaming rules found locally are applied, and aliases and/or renaming rules found at the server are also applied.

In another embodiment, each client machine periodically updates its own local data store using information from server-based data store. This can be done on a regular schedule, or in response to the server-based data store issuing a message indicating that it has received new data, or in response to the availability of a connection, or in response to some other trigger event. Then, when a client machine receives a downloaded transaction record, it checks its own local data store for aliases and/or renaming rules; it need not check the server-based data store, since the local data store has been regularly updated and already incorporates information from the server-based data store.

In one embodiment, the server-based data store contains categorization mapping for a payee, either in addition to or instead of aliases and/or renaming rules. Thus, the user need not enter categorization for a payee, as that information can be obtained from the server-based data store (or from the client machine's local data store, if it has been updated with information from the server-based data store).

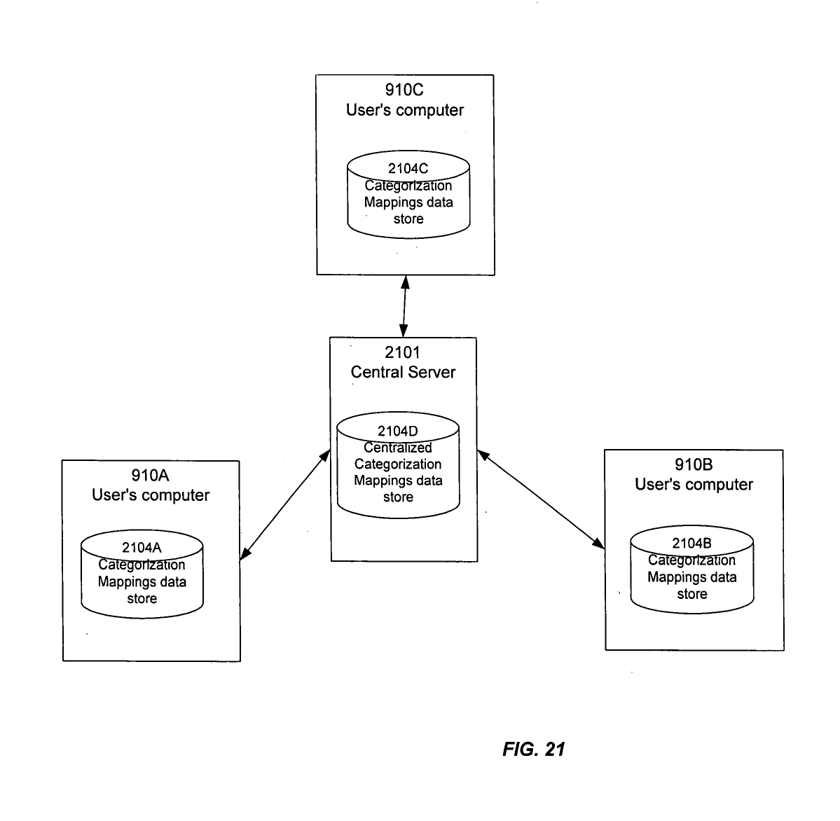

Referring now to FIG. 21, there is shown a block diagram depicting an architecture for implementing centralized storage of categorization mappings according to one embodiment. Centralized categorization mappings data store 2104D is located in or associated with central server 2101. Client machines such as users' computers 910A, 910B, and 910C communicate with central server 2101, for example over the Internet. Users' computers 910A, 910B, and 910C periodically transmit categorization mappings to central server 2101. Users' computers 910A, 910B, and 910C periodically receive categorization mappings from central server 2101, either in response to a need to check how a transaction record should be categorized, or in order to update their categorization mappings data stores 2104A, 2104B, 2104C.

In one embodiment, renaming and categorization information that is based on centrally-stored data is used as an initial default; the user is free to change the field value as desired. In another embodiment, renaming and categorization information that is based on centrally-stored data is used to populate a pop-up menu that allows the user to select among the most popular choices selected by other users. Items in the menu can be ranked according to their relative popularity. Selection of an item by a user can contribute to such popularity, so that the server-based data store keeps track of how many users selected each individual field value and/or category. Of course, the user can choose to enter his or her own field value and/or category, rather than selecting among the available choices.

In one embodiment, when presenting renaming, alias and/or categorization choices, those rules and mappings derived from the user's own behavior on his or her own machine take precedence over rules and mappings derived from server-based storage or other users' behavior. Thus, for example, even if other users tend to rename “PG&E 11394” to “PG&E”, if the user renames “PG&E 11394” to “Pacific Gas”, that alias relationship takes precedence over the “PG&E 11394”/“PG&E” alias relationship derived from other users' behavior.

One advantage of centralized storage is that one user can make use of renaming rules and/or aliases, as well as categorization mappings, developed in response to other users' behavior. Another advantage is that an individual user's renaming rules, aliases, and/or categorization mappings, can be made available to that user even if he or she is using a different computer (in a different location) than the computer that was used to generate the renaming rules, aliases and/or categorization mappings.

The following is an example of centralized storage for aliases and/or category mapping, according to one embodiment.

Step 1: At computer 910A, Kevin downloads transaction records from his bank, Wells Fargo. One of the transaction records reads as follows:

| Date | Payee | Category | Amount |
|---|---|---|---|
| Nov. 1, 2004 | PG & E BILL PAY 041029 | <categorize> | $49.72 |
| | 55149522652 <edit> | | |

Kevin edits the payee to just say “PG&E”, and enters a category of “Utilities.” The transaction record is updated as follows:

| Date | Payee | Category | Amount |
|---|---|---|---|
| Nov. 1, 2004 | PG&E | Utilities | $49.72 |

As described previously, two renaming rules are generated and stored in renaming rules data store 913A at Kevin's computer 910A: a “starts with” rule and an “equals” rule. In addition, a categorization mapping is created and stored in categorization mappings data store 2104A to associate PG&E with the Utilities category.

Step 2: Either immediately, or at some later time and date, centraized renaming rules data store 2103 is updated to include the two renaming rules that were stored in renaming rules data store 913A. Centralized categorization mappings data store 2104D is updated to include the new categorization mapping from categorization mappings data store 2104A. Such updates may be done immediately, or periodically, or in response to the availability of a data connection, or in response to any other trigger event.

Step 3: The next day, at a different computer 910B, another user, Dale, downloads transaction records from his bank, Bank of America. One of the transaction records reads as follows:

| Date | Payee | Category | Amount |
|---|---|---|---|
| Nov. 2, 2004 | PG & E BILL PAY 041109 | Utilities | $53.97 |
| | 55145222112 | | |

The category is already pre-filled, based on information from centralized categorization mappings data store 2104D that associates PG&E with the Utilities category. An indicator is presented adjacent to the field value, to show that a pop-up menu is available. If Dale clicks on the indicator, he is presented with alternative field values based on the renaming rules stored in centralized renaming rules data store 2103. In this example, the name “PG&E” is presented as an alternative choice. Dale can select “PG&E” from the pop-up menu if he would like to change the field value. (Alternatively, the software can automatically make this change for Dale, and allow him to reverse the change via the popup menu if desired. The selection of which mode of operation is used can depend on user preferences as specified via an options screen.)

A pop-up menu is also available for the Category field. If Dale clicks on the indicator, the pop-up menu is displayed. It contains other categories that have been selected by other users, in descending order of popularity. Dale is free to select among the choices in the pop-up menu, or to enter his own choice.

Once Dale selects a field value and category, his choices are memorized so that future PG&E transaction records can be renamed and recategorized automatically without requiring Dale to manually effect such changes. Such memorization can take place by locally storing his choices at Dale's computer 910B, or by centrally storing the changes and associating them with Dale.

In addition, Dale's choices contribute to the relative popularity of those renaming and categorization selections.

This example assumes that no corroboration is needed. In an embodiment where corroboration is required before a renaming rule, alias, or categorization mapping is made available for use, some number of users (besides Kevin) would have to make the same (or similar) choices before the choices appeared on Dale's computer.

Step 4: As more users rename and categorize PG&E transactions, centralized renaming rules data store 2103 and categorization mappings data store 2104D keep track of all the selections made by users. When a user receives a PG&E transaction record, the top N choices of field value and categorization are shown in the pop-up menus, according to descending order of popularity. For example, suppose Alice downloads a transaction record as follows:

| Date | Payee | Category | Amount |
|---|---|---|---|
| Nov. 3, 2004 | PG & E BILL PAY 041109 | Utilities | $26.44 |
| | 55145222112 | | |

As before, indicators are provided next to the field value and default Utilities category. If Alice clicks on the pop-up indicator next to the field value, she is presented with a number of options, such as “PG&E”, “Pacific Gas & Electric”, and the like, in descending order of popularity. Similarly, if Alice clicks on the pop-up indicator next to the Utilities category, she is presented with a number of options, such as “Electric”, “Gas”, “Household”, and the like, in descending order of popularity. In this example, the category field is pre-filled with the most popular choice, so that if Alice wishes to use that category she need not do anything.

Centralized storage takes advantage of choices made by large numbers of users in a user base, and learns from such choices. A high degree of popularity of a particular choice tends to indicate that it is of greater likelihood to be the correct choice for an individual user. Of course, the present invention still allows each individual user to provide his or her own individual choices, and further recognizes that users would like those individual choices to be memorized and to take precedence over choices made by others, even if those choices of others are quite popular.

In the above description, for purposes of explanation, numerous specific details are set forth in order to provide a thorough understanding of the invention. It will be apparent, however, to one skilled in the art that the invention can be practiced without these specific details. In other instances, structures and devices are shown in block diagram form in order to avoid obscuring the invention.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

Some portions of the detailed description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present invention also relates to an apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms and modules presented herein are not inherently related to any particular computer or other apparatus. Various general-purpose systems may be used with programs in accordance with the teachings herein, or it may prove convenient to construct more specialized apparatuses to perform the method steps. The required structure for a variety of these systems will appear from the description below. In addition, the present invention is not described with reference to any particular programming language. It will be appreciated that a variety of programming languages may be used to implement the teachings of the invention as described herein. Furthermore, as will be apparent to one of ordinary skill in the relevant art, the modules, features, attributes, methodologies, and other aspects of the invention can be implemented as software, hardware, firmware or any combination of the three. Of course, wherever a component of the present invention is implemented as software, the component can be implemented as a standalone program, as part of a larger program, as a plurality of separate programs, as a statically or dynamically linked library, as a kernel loadable module, as a device driver, and/or in every and any other way known now or in the future to those of skill in the art of computer programming. Additionally, the present invention is in no way limited to implementation in any specific operating system or environment.

In addition, the above description sets forth the invention in terms of setting up aliasing and/or renaming rules for payees. One skilled in the art will recognize that the above-described invention can also be applied to setting up aliasing and/or renaming rules for payers, and/or for any other entities or descriptive information concerning transactions.

It will be understood by those skilled in the relevant art that the above-described implementations are merely exemplary, and many changes can be made without departing from the true spirit and scope of the present invention. Therefore, it is intended by the appended claims to cover all such changes and modifications that come within the true spirit and scope of this invention.

What is claimed is:

1. A computer-implemented method for associating a transaction record with an alias, comprising:
receiving a transaction record including a field value;
determining whether the field value of the transaction record corresponds to a stored field value in a data store; and
responsive to the field value of the transaction record not corresponding to any stored field value in the data store:
responsive to the field value of the transaction record corresponding to a stored alias, the stored alias referencing a stored field value, associating the transaction record with the field value referenced by the alias.

2. The method of claim 1, wherein associating the transaction record with the field value referenced by the alias comprises replacing the field value of the transaction record with the field value referenced by the alias.

3. The method of claim 1, wherein associating the transaction record with the field value referenced by the alias comprises adding the field value referenced by the alias to the transaction record.

4. The method of claim 1, wherein associating the transaction record with the field value referenced by the alias comprises storing, in the transaction record, a reference to the field value referenced by the alias.

5. The method of claim 1, further comprising:
responsive to the field value of the transaction record not corresponding to any stored field value in the data store and not corresponding to a stored alias, performing at least one selected from the group consisting of:
storing a new record in the data store, the new record comprising the field value of the transaction record;
storing a new alias corresponding to the field value of the transaction record, the new alias referencing a stored field value.

6. The method of claim 5, further comprising receiving a user selection specifying whether to store a new record in the data store or to store a new alias, and wherein the storing step is performed according to the received user selection.

7. The method of claim 1, wherein the field value comprises a payee name.

8. The method of claim 1, wherein the field value comprises a payer name.

9. The method of claim 1, wherein the field value comprises a memo.

10. The method of claim 1, wherein receiving the transaction record comprises downloading the transaction record from an online source.

11. The method of claim 1, wherein receiving the transaction record comprises receiving user input describing a transaction.

12. The method of claim 1, further comprising storing the transaction record.

13. The method of claim 1, wherein the field value of the transaction record comprises extraneous information not present in the stored field value referenced by the alias.

14. The method of claim 1, further comprising:
responsive to the field value of the transaction record not corresponding to any stored field value in the data store and not corresponding to a stored alias and not corresponding to a pre-designated stop phrase, performing at least one selected from the group consisting of:
storing a new record in the data store, the new record comprising the field value of the transaction record;
storing a new alias corresponding to the field value of the transaction record, the new alias referencing a stored field value.

15. A computer-implemented method for renaming a field value, the method comprising:
receiving a transaction record including an original field value; and
responsive to a stored renaming rule being applicable to the original field value, associating the transaction record with a substitute field value referenced by the renaming rule.

16. The method of claim 15, further comprising:
responsive to user input renaming the original field value, creating a renaming rule applicable to the original field value; and
storing the created renaming rule.

17. The method of claim 15, further comprising:
responsive to user input renaming the original field value, creating a renaming rule specifying that a text field equal to the original field value shall be replaced by the substitute field value; and
storing the created renaming rule.

18. The method of claim 15, further comprising:
responsive to user input renaming the original field value, creating a renaming rule specifying that a text field starting with text equal to the substitute field value shall be replaced by the substitute field value; and
storing the created renaming rule.

19. The method of claim 15, further comprising:
responsive to user input renaming the original field value:
creating a first renaming rule specifying that a text field equal to the original field value shall be replaced by the substitute field value; and
creating a second renaming rule specifying that a text field starting with text equal to the substitute field value shall be replaced by the substitute field value; and
storing the created renaming rules.

20. The method of claim 15, wherein associating the transaction record with the substitute field value comprises replacing the original field value with the substitute field value.

21. The method of claim 15, wherein associating the transaction record with the substitute field value comprises adding the substitute field value to the transaction record.

22. The method of claim 15, wherein associating the transaction record with the substitute field value comprises storing, in the transaction record, a reference to the substitute field value.

23. The method of claim 15, further comprising:
responsive to user input renaming the original field value, prompting the user as to whether to create a renaming rule; and
responsive to user input indicating that a renaming rule should be created:
creating a renaming rule applicable to the original field value; and
storing the created renaming rule.

24. The method of claim 15, wherein the original field value comprises a payee name.

25. The method of claim 15, wherein the original field value comprises a payer name.

26. The method of claim 15, wherein the original field value comprises a memo.

27. The method of claim 15, wherein receiving the transaction record comprises downloading the transaction record from an online source.

28. The method of claim 15, wherein receiving the transaction record comprises receiving user input describing a transaction.

29. The method of claim 15, further comprising storing the transaction record.

30. The method of claim 15, wherein the renaming rule specifies that a field value equal to a target string shall be replaced by a substitute field value.

31. The method of claim 15, wherein the renaming rule specifies that a field value starting with a target string shall be replaced by a substitute field value.

32. The method of claim 15, wherein the renaming rule specifies that a field value containing a target string shall be replaced by a substitute field value.

33. A computer-implemented method for renaming a field value, the method comprising:
receiving, at a first computer, a transaction record including a field value;
determining whether the field value of the transaction record corresponds to an alias in a data store of alias records; and
responsive to the field value of the transaction record corresponding to an alias, associating the transaction record with a field value referenced by the alias;
wherein the data store of alias records comprises at least one alias generated by a second computer different from the first computer.

34. The method of claim 33, wherein the first and second computers are located remotely with respect to one another.

35. The method of claim 33, wherein the first and second computers are operated by different users.

36. The method of claim 35, wherein the field value comprises a payee name.

37. A computer-implemented method for renaming a field value, the method comprising:
receiving, at a first computer, a transaction record including a field value of the transaction;
determining whether the field value of the transaction record corresponds to a renaming rule in a data store of renaming rules; and
responsive to the field value of the transaction record corresponding to a renaming rule, renaming the field value of the transaction record according to the renaming rule;
wherein the data store of renaming rules comprises at least one renaming rule generated by a second computer different from the first computer.

38. The method of claim 37, wherein the first and second computers are located remotely with respect to one another.

39. The method of claim 37, wherein the first and second computers are operated by different users.

40. The method of claim 37, wherein the field value comprises a payee name.

41. A computer-implemented method for categorizing a financial transaction record, the method comprising:
receiving, at a first computer, a transaction record including a field value;
determining whether the field value of the transaction record corresponds to a category in a data store of mappings between field values and categories; and
responsive to the field value of the transaction record corresponding to a category, applying the category to the received financial transaction record;
wherein the data store of mappings comprises at least one mapping generated by a second computer different from the first computer.

42. The method of claim 41, wherein the first and second computers are located remotely with respect to one another.

43. The method of claim 41, wherein the first and second computers are operated by different users.

44. The method of claim 41, wherein the field value comprises a payee name.

45. A computer program product for associating a transaction record with an alias, comprising:
a computer-readable medium; and
computer program code, encoded on the medium, for:
receiving a transaction record including a field value;
determining whether the field value of the transaction record corresponds to a stored field value in a data store; and
responsive to the field value of the transaction record not corresponding to any stored field value in the data store:
responsive to the field value of the transaction record corresponding to a stored alias, the stored alias referencing a stored field value, associating the transaction record with the field value referenced by the alias.

46. A computer program product for renaming a field value, the computer program product comprising:
a computer-readable medium; and
computer program code, encoded on the medium, for:
receiving a transaction record including an original field value; and
responsive to a stored renaming rule being applicable to the original field value, associating the transaction record with a substitute field value referenced by the renaming rule.

47. A computer program product for renaming a field value, the computer program product comprising:
a computer-readable medium; and
computer program code, encoded on the medium, for:
receiving, at a first computer, a transaction record including a field value;
determining whether the field value of the transaction record corresponds to an alias in a data store of alias records; and
responsive to the field value of the transaction record corresponding to an alias, associating the transaction record with a field value referenced by the alias;
wherein the data store of alias records comprises at least one alias generated by a second computer different from the first computer.

48. A computer program product for renaming a field value, the computer program product comprising:
a computer-readable medium; and
computer program code, encoded on the medium, for:
receiving, at a first computer, a transaction record including a field value of the transaction;
determining whether the field value of the transaction corresponds to a renaming rule in a data store of renaming rules; and
responsive to the field value of the transaction corresponding to a renaming rule, renaming the field value of the transaction according to the renaming rule;
wherein the data store of renaming rules comprises at least one renaming rule generated by a second computer different from the first computer.

49. A computer program product for categorizing a financial transaction record, the computer program product comprising:
a computer-readable medium; and
computer program code, encoded on the medium, for:
receiving, at a first computer, a transaction record including a field value;
determining whether the field value of the transaction record corresponds to a category in a data store of mappings between field values and categories; and
responsive to the field value of the transaction record corresponding to a category, applying the category to the received financial transaction record;
wherein the data store of mappings comprises at least one mapping generated by a second computer different from the first computer.

50. A system for associating a transaction record with an alias, comprising:
an input device, for receiving a transaction record including a field value;
a field value data store, for storing field values;
an alias store, for storing aliases;
an aliasing module, coupled to the input device and to the data stores, for:
determining whether the field value of the transaction record corresponds to a stored field value in the data store; and
responsive to the field value of the transaction record not corresponding to any stored field value in the data store:
responsive to the field value of the transaction record corresponding to a stored alias, the stored alias referencing a stored field value, associating the transaction record with the field value referenced by the alias.

51. A system for renaming a field value, the system comprising:
an input device, for receiving a transaction record including an original field value;
a renaming rules alias store, for storing renaming rules;
a renaming module, coupled to the input device and to the renaming rules alias store, for, responsive to a stored renaming rule being applicable to the original field value, associating the transaction record with a substitute field value referenced by the renaming rule.

52. A system for renaming a field value, the system comprising:
an input device at a first computer, for receiving a transaction record including a field value;
a data store, comprising alias records and comprising at least one alias generated by a second computer different from the first computer; and
a processor at the first computer, coupled to the input device and to the data store, for:
determining whether the field value of the transaction record corresponds to an alias in the data store; and
responsive to the field value of the transaction record corresponding to an alias, associating the transaction record with a field value referenced by the alias.

53. A system for renaming a field value, the system comprising:
an input device at a first computer, for receiving a transaction record including a field value of the transaction record;
a data store, comprising renaming rules and comprising at least one renaming rule generated by a second computer different from the first computer; and
a processor at the first computer, coupled to the input device and to the data store, for:
determining whether the field value of the transaction record corresponds to a renaming rule in the data store; and
responsive to the field value of the transaction record corresponding to a renaming rule, renaming the field value of the transaction record according to the renaming rule.

54. A system for categorizing a financial transaction record, the system comprising:
an input device at a first computer, for receiving a transaction record including a field value;
a data store, comprising mappings between field values and categories, and comprising at least one mapping generated by a second computer different from the first computer; and
a processor at the first computer, coupled to the input device and to the data store, for:
determining whether the field value of the transaction record corresponds to a category in the data store; and
responsive to the field value of the transaction record corresponding to a category, applying the category to the received financial transaction record.
